(19) United States
(12) Patent Application Publication
(10) Pub. No.: US 2022/0309584 A1
(43) Pub. Date: Sep. 29, 2022

(54) Energy of financial instruments

(71) Applicant: David Andrew D'Zmura, San Diego, CA (US)

(72) Inventor: David Andrew D'Zmura, San Diego, CA (US)

(21) Appl. No.: 16/974,270

(22) Filed: Dec. 14, 2020

(51) Int. Cl. G06Q 40/06

(52) U.S. Cl. CPC G06Q 40/06

(57) ABSTRACT

The invention comprises a process rendering data of the energy of a financial instrument calculated from said instrument's endogenous variables of annual coupon rate and years-to-maturity. The invention further comprises a process rendering data of the relativistic kinetic energy of a financial instrument calculated from said instrument's endogenous variables of annual coupon rate, years-to-maturity, and annual yield. The total energy of said instrument is further calculated. The invention demonstrates the use of the financial data in display, in print and in computer and paper storage. The invention also comprises a method to augur price change of a financial instrument, and this invention further comprises a spreadsheet to implement the method and to test its efficacy.

### PRIORITY APPLICATIONS

My priority Applications are: 61/001,436 of Nov. 1, 2007; 61/997,578; Ser. Nos. 12/928,357; and 13/317,276. The matter herein has never been published, and was not a part of matter published in Ser. No. 12/928,357.

### TECHNICAL FIELD

This invention produces an augur of the forthcoming market occurrence regarding a fixed-income (bond) security, as well as to all securities individually comprising a grouping, to its price moving up or down, hence the augur forecasts the directionality which governs, further, whether to buy or to sell the instrument. The financial instrument(s) is therefore forecast for its expectation to appreciate or to depreciate in value. The augur comprises novel formulae which render unique variables and data, which, as described herein, when operated in the novel method, produce reliable indicator, said indicator testing as a useful tool, having efficacy of or exceeding one full standard deviation above a 50/50 random selection, proving its utility. This invention has an automated device, an interlocking spreadsheet, which augurs upon inputs.

### DESCRIPTION OF THE INVENTION

The expectation of a financial instrument to appreciate or to depreciate in value is, by this invention, determined by the endogenous variables to a fixed-income security: its maturity (in years); its coupon rate of interest annually and periodically; and its yield per annum (defined by its price, maturity and coupon and par rate). Hence, no stochastic or statistical means or databases are used, nor is it operated by time series, correlation or co-variance. The central fathom in finance states all information is contained in price, wherein this invention augurs price change solely by the bond's endogenous variables at moment X.

The Energy of Financial Instruments is given by the physics Law: E=mc², wherein

Energy_{(financial instrument)}=Mass_{(financial instrument)} [Constant of Rate of Speed_{(financial instrument)}]².

Specifically, for fixed-income securities bearing a maturity date and a set payment of interest:

Energy_{(financial instrument)}=Years to Maturity_{(financial instrument)} [Coupon of Rate_{(financial instrument)}]².

This holds as long as the instrument is not traded during its lifetime. However, in the relativistic environment of actively traded bonds, as well as the co-reciprocity between instruments of a class, the variable of yield is essential to introduce, as it relates price, interest payment and years to maturity, wherein:

$$Relativistic Kinetic Energy ( RKE ) = \frac{{mc}^{2}}{\sqrt{/ 1 - \frac{{u}^{2}}{{c}^{2}} /}} - {mc}^{2} \\ where m = mass of instrument ( years to maturity ) \\ c = constant of rate of speed ( annual coupon rate ) \\ u = yield ( annualized basis ) .$$

Note: The augur device, the automated spreadsheet, utilizes the input variable data of m, c, and u as years to maturity in decimal accuracy, the decimal coupon rate and the decimal yield. If one entered the coupon rate as a percentage of par 100 bond face amount, and similarly yield so as well, one would realize the same numeric output except scaled 100 times higher times 100 times higher, for a scale multiplier of 10,000.

Thus, the instrument's Total Energy follows physics formulation:

Total Energy(TE)=RKE+mc².

These Formulas are readily calculated by computational means including computer or calculator:

Energy (as computational code): E=m*(c\hat{ }2);

Relativistic Kinetic Energy (as computational code):

RKE=((m*(c\hat{ }2))/(SQRT(ABS(1−(u\hat{ }2)/(c\hat{ }2))))))−(m*(c\hat{ }2));

Total Energy (as computational code): TE=RKE+(m*(c\hat{ }2));
where m=mass of instrument (years to maturity)
c=constant of rate of speed (annual coupon rate)
u=yield (annualized basis).

To begin the computational method to producing an augur of price increase or decrease (herein, price “up” or “down”, respectively) first one utilizes the inputs of m, c and u and calculates the RKE of the financial instrument, or the RKE of each financial instrument comprising a group.

Second, one calculates the Vector for RKE, by the specific RKE for each instrument (1, 2, . . . ): Vector RKE(1)=RKE(1); Vector RKE(2)=RKE(2)−Vector RKE(1); . . .

Third, one computes the Normalizer for each instrument, the difference between RKE and TE, thus TE is calculated, then: Normalizer(1)=(−mc² (1)); Normalizer(2)=(−mc² (2)); . . .

Fourth, one calculates the Normalizing Vector for RKE, by the specific Normalizer for each instrument: NormVecRKE(1)=(−Norm(1)); NormVecRKE(2)=NormVecRKE(1)+(−Norm(2)); . . .

Fifth and finally, one calculates the difference between the Normalizing Vector for RKE of each instrument and its Vector for RKE: NVRKE−VRKE=NormVecRKE(1)−VectorRKE(1); . . .

This final value is the prognosticating indicator of each security's likelihood to gain or lose in value, “up” or “down” respectively, positive difference augurs to gain, and negative, to lose, in value.

Because of the formula for RKE, whereby, an instrument trading very near to , or at, par, will have yield and coupon equal, or nearly so, this ‘blowing up’, or distorting, the RKE value. Consequently, the security next following such an example, will nearly always have substantially lower RKE, and the difference will then become precipitous, very often creating a false signal. Hence, a warning of “with Trend” signal can automatically flag, for instance, set at:
if((1.8*RKE(2))<RKE(1), “with Trend”), and its direction is with nearby clean signals.
   The “with Trend” signal is tested and if signalled, the instrument's direction is determined by fitting it to the trend established by neighboring instruments with clean, “OK”, signals. Hence, the “Fitted” column.

### DESCRIPTION OF THE DRAWINGS

The Figures display the automated augur device, the interlocking spreadsheet for a grouping of U.S. Treasury fixed-income instruments at several different epochs, testing and demonstrating the Formulas, their computational coding, the method of auguring, and actual pricing results during the tested epochs.

Each drawing tests seven U.S. Treasury fixed-income financial instruments comprising a ladder, by entering years to maturity, coupon rate, and yield, the m, c, and u values respectively, for each instrument, thereupon, the spreadsheet performs the method of augury for each, calculating the unique and novel value for each variable stepwise, comprising the method to augur. The results of each step are shown sequentially.

The spreadsheet concludes by providing the “up” or “down” prognosis of the instrument's values going up or down, respectively. To track efficacy, the price and the three endogenous variables are entered for each of three dates, approximately two to three weeks apart, and the actual price results are compared to the augury signal, rendering the proficiency of the augur method to prognosticate the movement accurately. The spreadsheet concludes with the signal accuracy stated for each test date within the sampled epoch.

FIG. 1 show the sampled epoch comprising Mar. 22, 1996, Apr. 3, 1996 and Apr. 25, 1996, for each of these dates, computing an augur. Here, it is predominantly indicating “down” signals. Indeed, the price of the financial instruments did head downwards as prognosticated, for an accuracy of 95%, two standard deviations above a 50/50 random selection, thus, the augury technologies, are very useful tools.

FIG. 1A is the left-hand side of the spreadsheet, whereas FIG. 1B is the right-hand side of the spreadsheet. For each of these two pages, the upper portion has the data for seven fixed-income Treasury financial instruments, sorted by maturity date. The spectrum of the seven securities covers the short- to mid-term maturities. The data for these financial instruments are given for years-to-maturity (m), coupon (c), yield (u) and price for each instrument in data blocks for each of the three testing dates. Further, on the left-hand figure, the Relativistic Kinetic Energy (RKE) and the Total Energy (TE) are computed and provided for each financial instrument for each of the three testing dates. The data for each security is continued on the right-hand figure, here FIG. 1B. These data implement the augur method, and commences by calculating the Vector RKE (VecRKE), the Normalizer (NormTE), the Normalizing Vector for RKE (NormVec), and the difference between the Normalizing Vector and the Vector RKE (NV-V). Next, the augur is calculated and registers “up” or “down”, followed by the trend test whereby the “with Trend” indicates the warning to “fitted” to apply neighboring direction to the flagged augur. The bottom of the left-hand sheet, FIG. 1A, displays the price change computation between the testing dates, and serves to track the efficacy of the augur method. The bottom of the right-hand sheet, FIG. 1B, displays the Signal Accuracy of the augur signals recorded above, as compares to the price change noted for each security between testing dates. The remainder of the drawings comprise pairings of the left-hand and right-hand sides of the invented spreadsheet.

FIG. 2 show the sampled epoch comprising Mar. 12, 2013, Apr. 3, 2013 and Apr. 23, 2013, for each of these dates, computing an augur. FIGS. 2A and 2B render the left-hand and right-hand sides of the augur spreadsheet, respectively. Here, it is predominantly indicating “up” signals, that the price of the seven U.S. Treasuries will increase in value during the epoch. Indeed, the price of the financial instruments did head upwards, as prognosticated, for an accuracy of 67%, one standard deviation above a 50/50 random selection, thus, the augury technologies are shown to be useful tools. Further, the FIGS. 2C and 2D show a group of U.S. Treasuries of medium- and long-term maturities. For this group, the augur indicates uniformly “up” signals, and indeed the prices of each Treasury rose during the epoch for 100% accuracy. The efficacy of the augur, therefore, increased when the selected instruments were medium- and long-term.

FIG. 3 show the sampled epoch comprising Dec. 8, 2015, Dec. 30, 2015 and Jan. 20, 2016, for each instrument at each of these dates, computing an augur. FIGS. 3A and 3B are the left-side and right-side of the augur spreadsheet, respectively. FIGS. 3C and 3D are the left-side and right-side of the augur spreadsheet, respectively, for a group of seven medium- to long-term maturities. Here, it is predominantly indication “up” signal, that the price of the seven short- to medium-term, as well as the seven medium- to long-term will rise in value during the period of the epoch; indeed, the price of the financial instruments died head upwards, as prognosticated, for an accuracy of 62% and 71% for the two groups, respectively. Thus, the augur demonstrates as a useful tool, exceeding random selection by one standard deviation (67%).

FIG. 4 show the sampled epoch comprising Oct. 4, 2018, Oct. 23, 2018 and Nov. 8, 2018, for each of a group of short- to medium-term financial instruments. FIGS. 4A and 4B render the data for these three testing dates, with FIG. 4A the left-hand side and FIG. 4B the right-hand side of the spreadsheet, respectively. Additionally the sampled epoch is extended to Nov. 29, 2018 and to Dec. 13, 2018. The FIG. 4C is the left-hand side, and the FIG. 4D the right-hand side, of the spreadsheet, respectively, for these testing dates. This epoch was not randomly selected as the others were, but is a period in which exogenous forces act upon the instruments' prices, as the Federal Reserve raised the discount rate on Sep. 27, 2018. The tested epoch shows that the external intervention lowers price, as expected, despite the predominantly “up” signals of the endogenous factors themselves. In the second leg of the epoch, the “up” signals regained control over the market movement, and the prices of the instruments headed higher as augured. For the entire epoch, the price increase exceeded the intervention's decrease, with an accuracy of 95%.

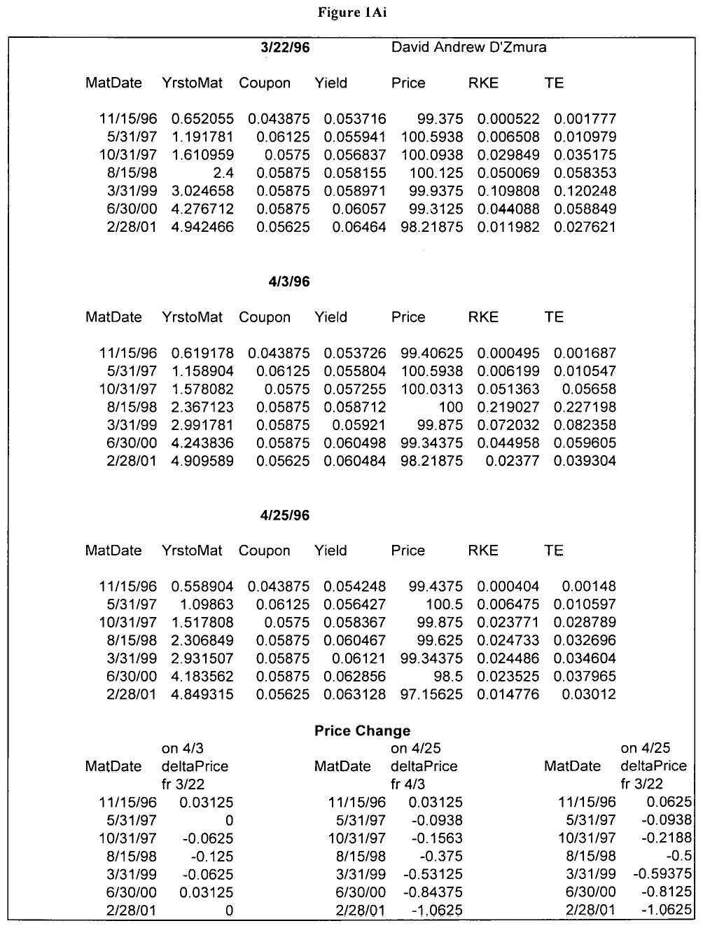

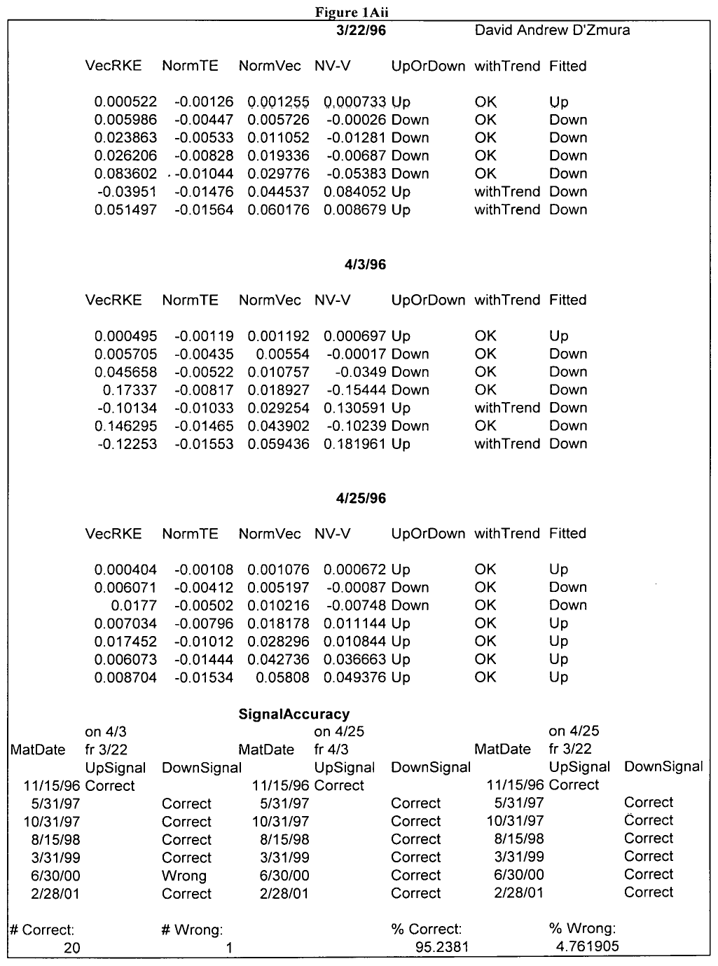

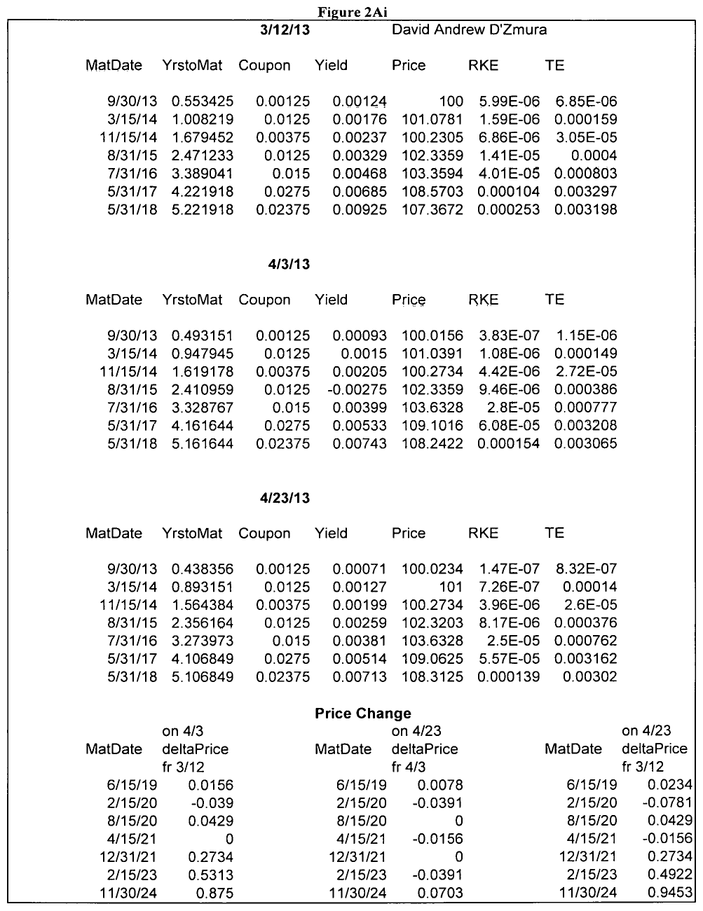

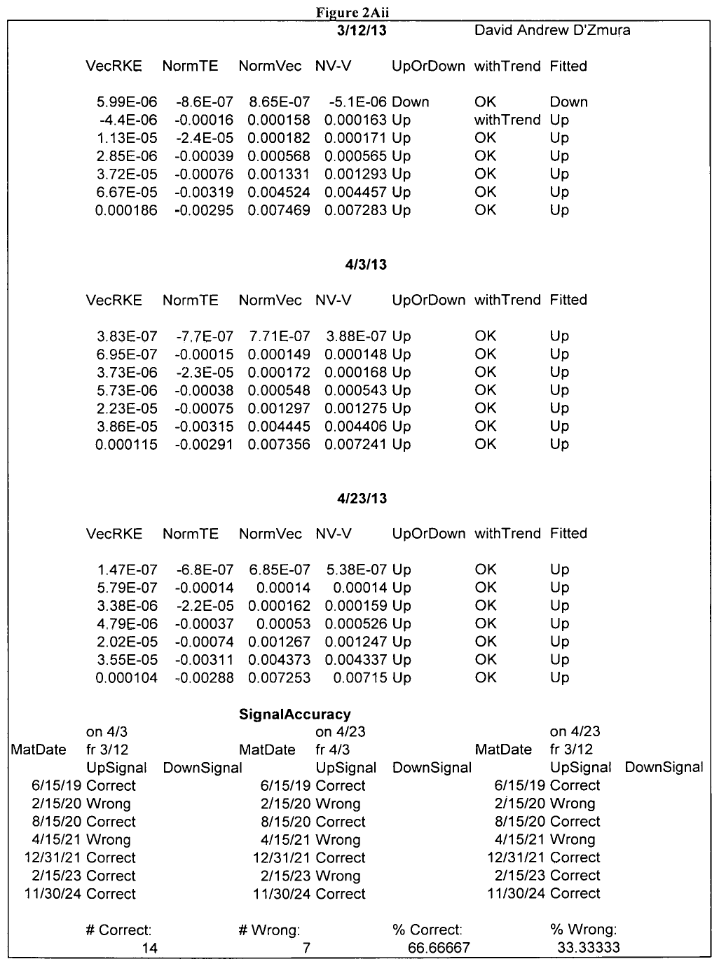

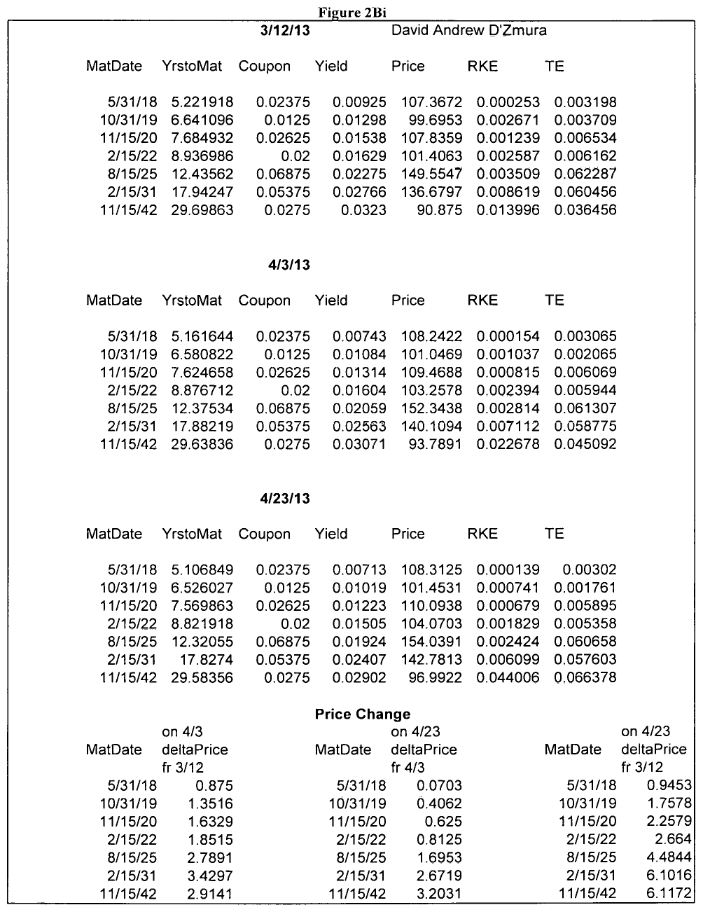

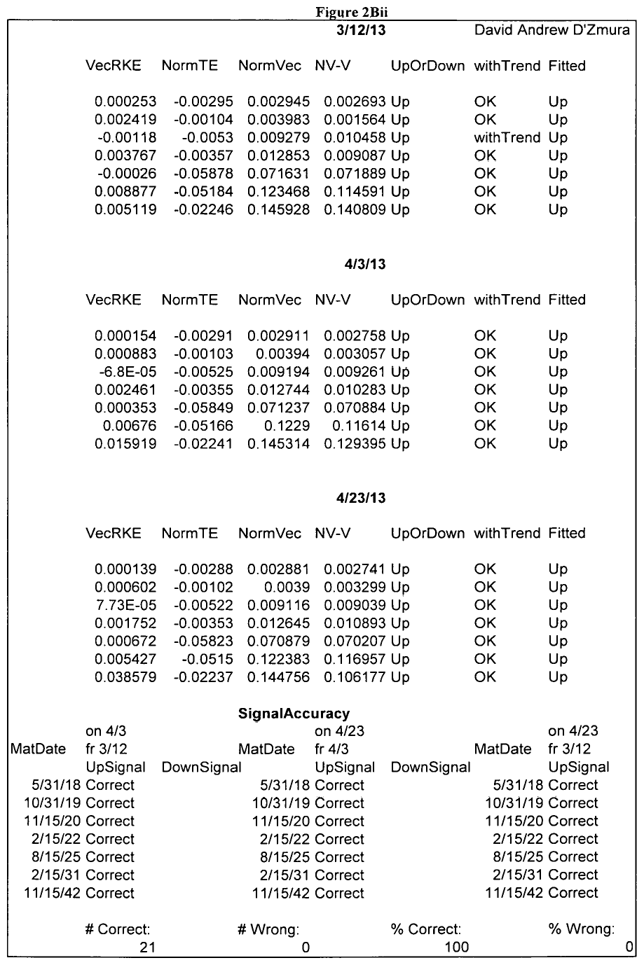

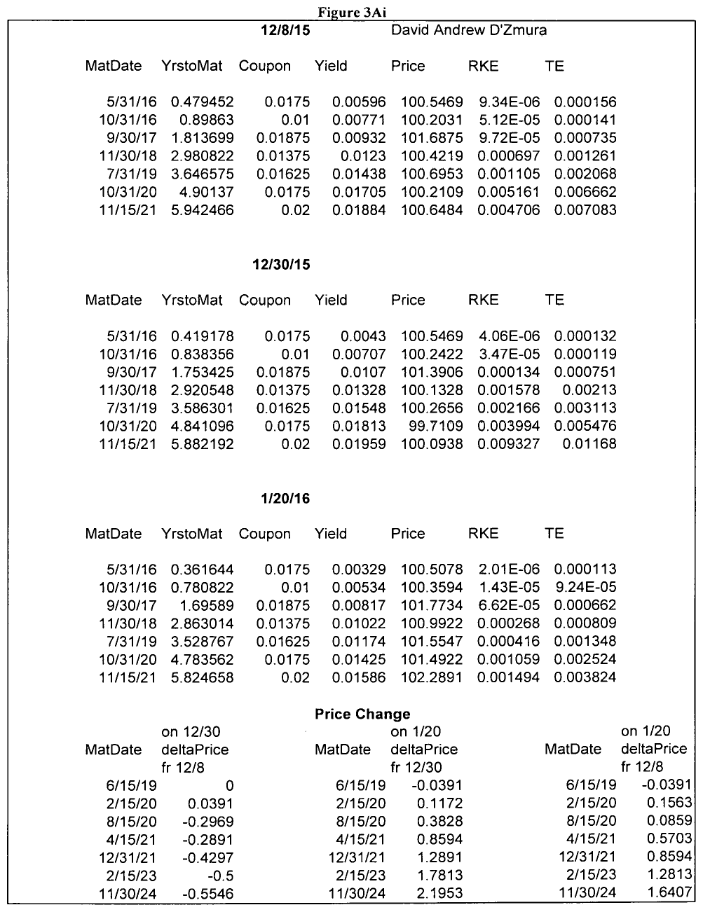

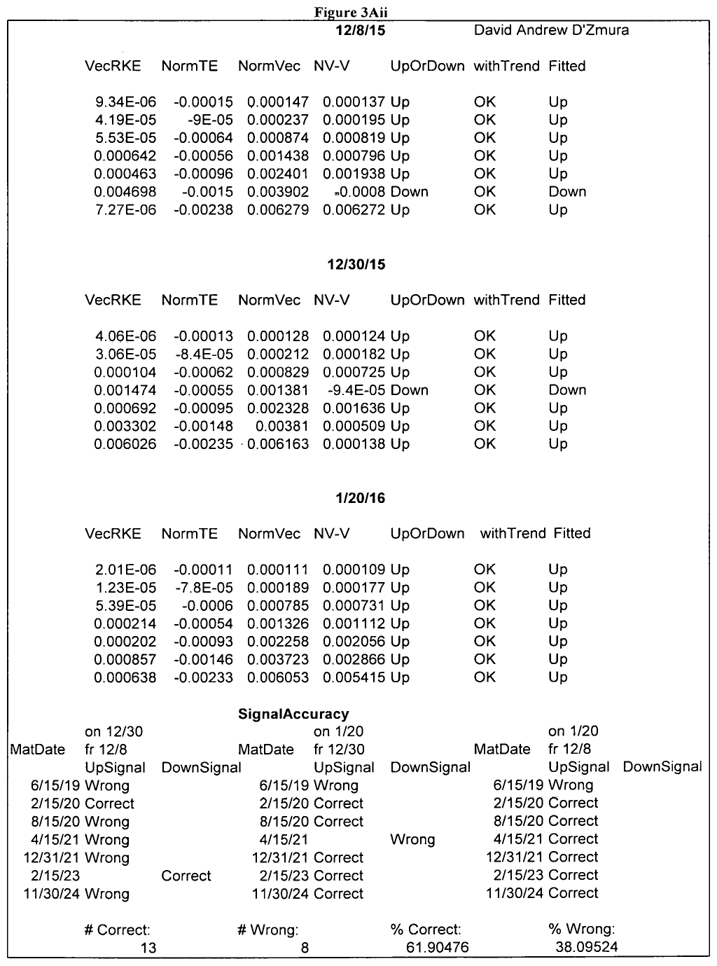

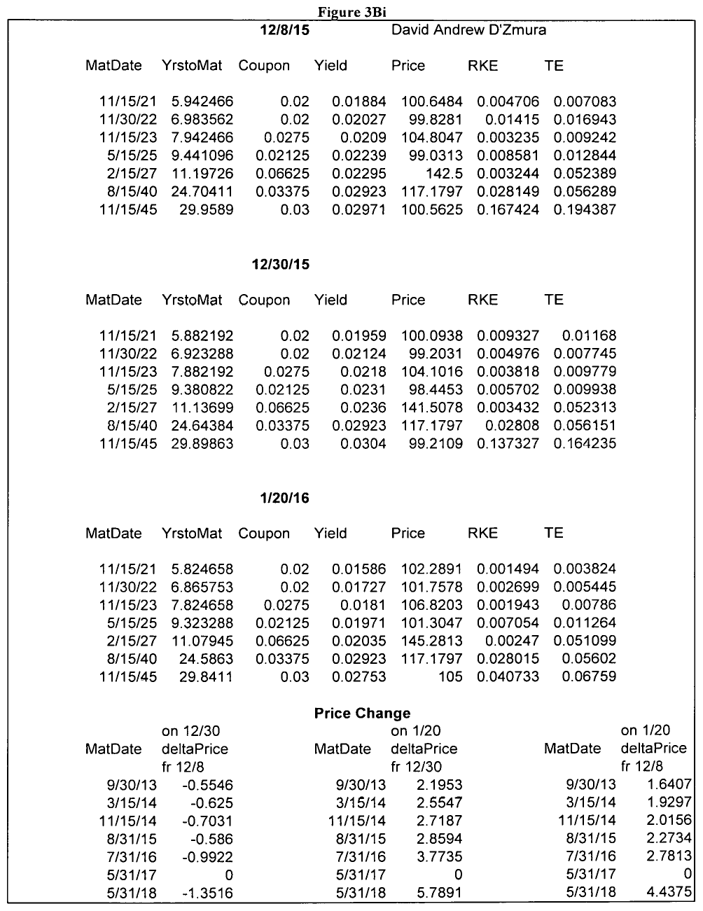

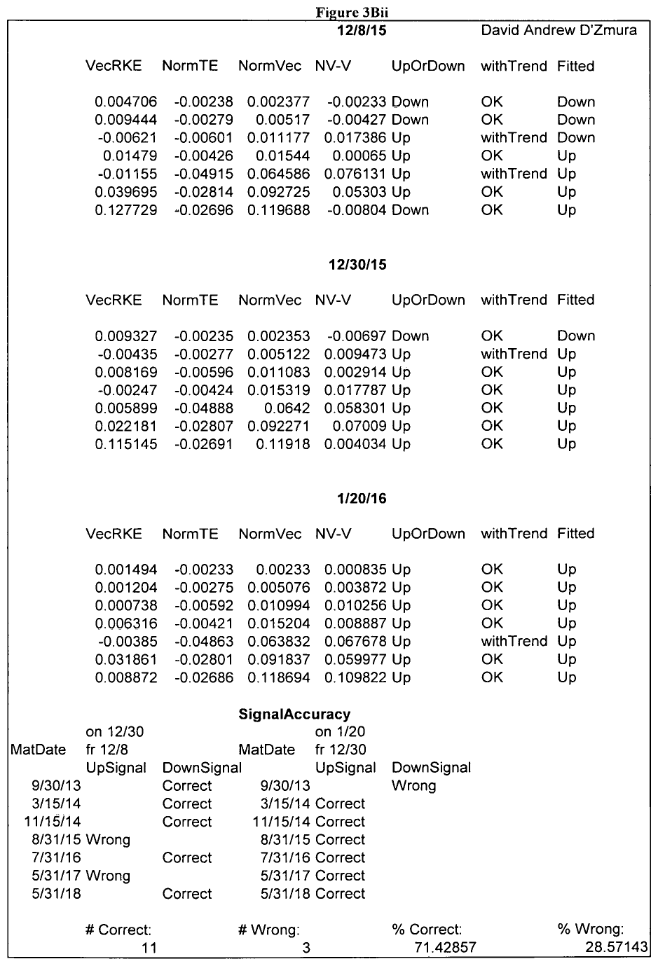

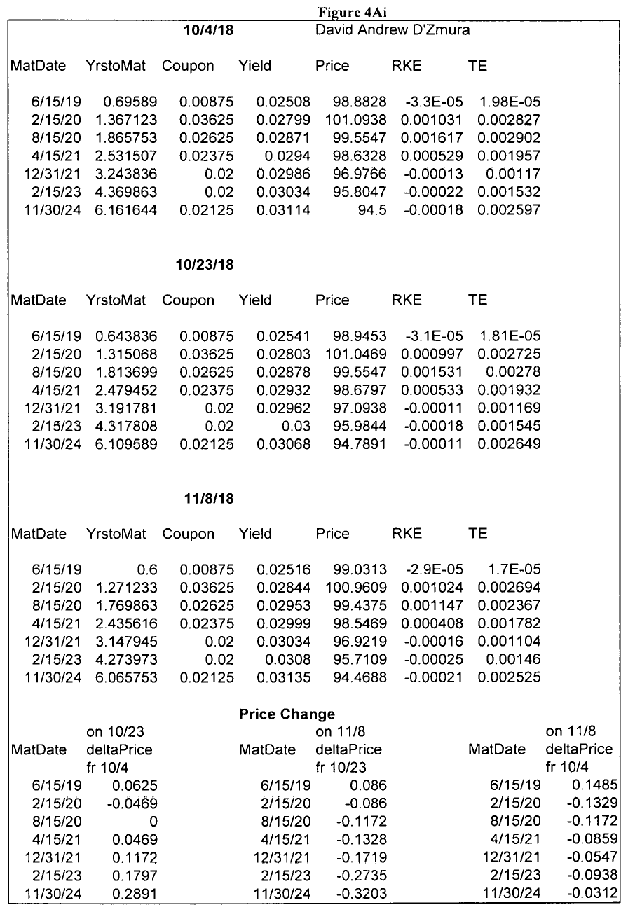

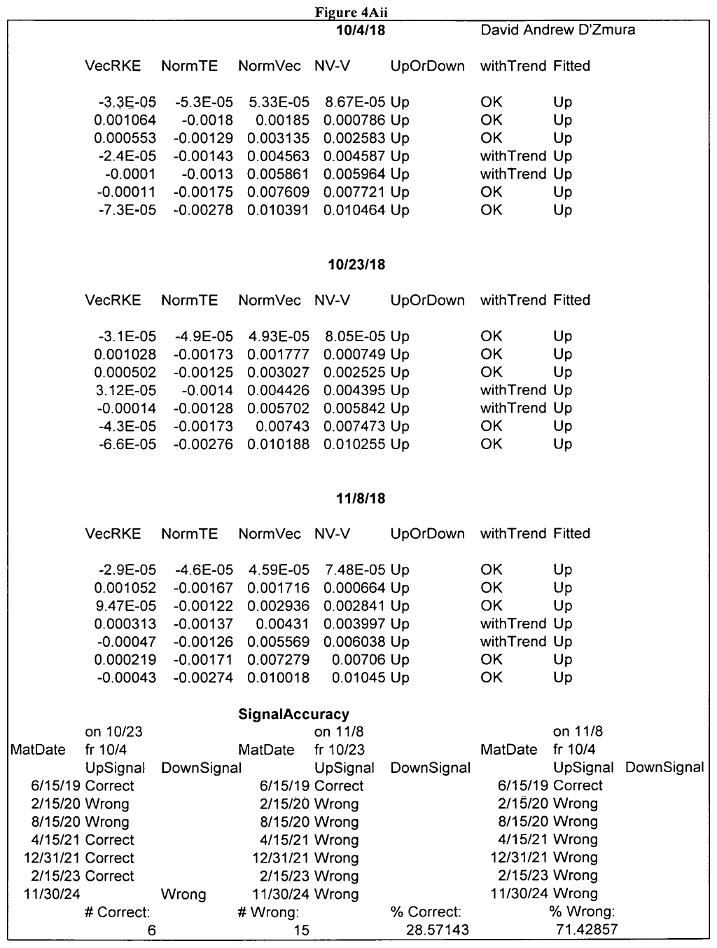

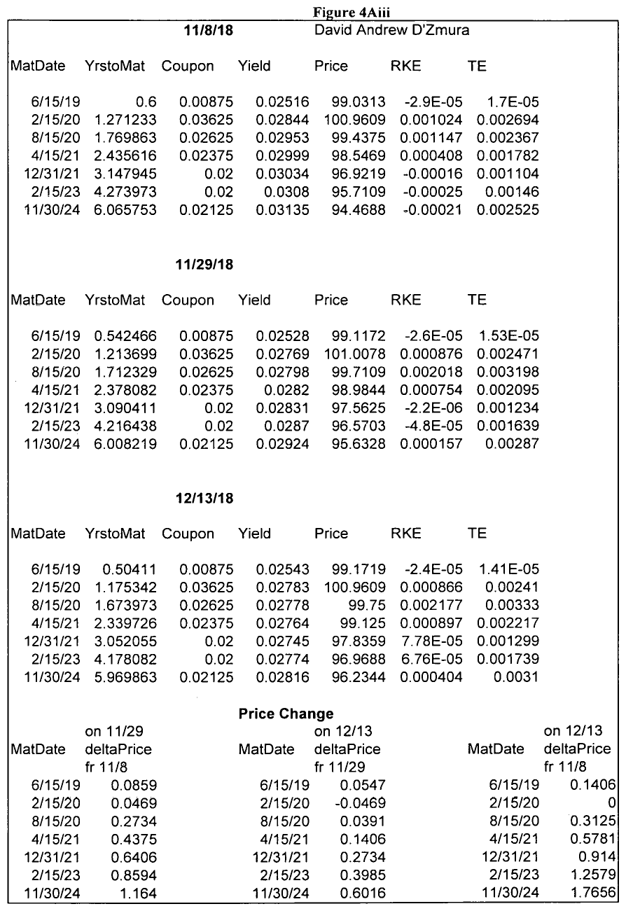

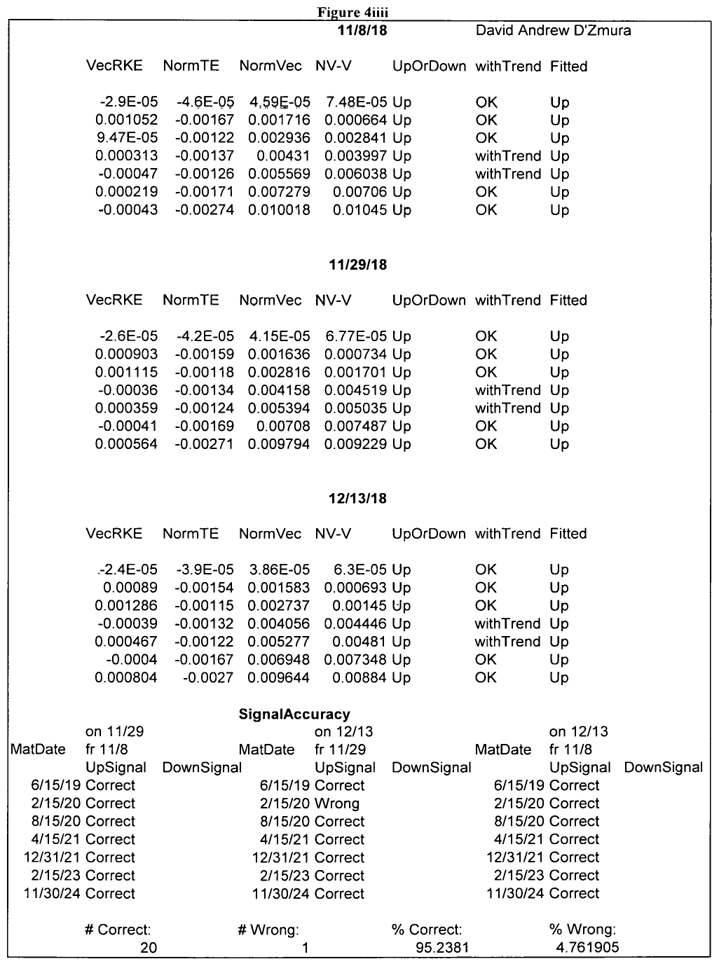

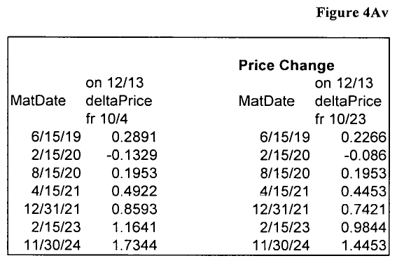

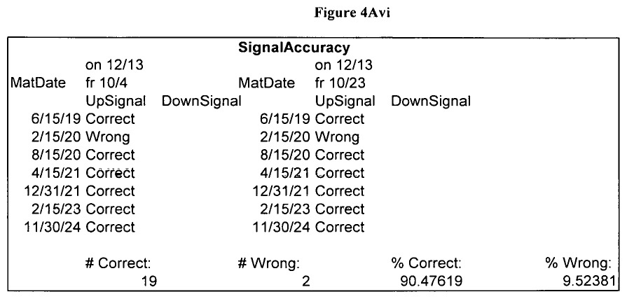

What I claim is:

1. A process determining the energy of a financial instrument, and producing data, wherein said energy of a financial instrument given by the Law of Physics, E =mc²
wherein
Energy_{(financial instrument)}=Mass_{(financial instrument)} [Constant of Rate of Speed_{(financial instrument)}]².
wherein further comprising for fixed-income securities bearing a maturity date and a set payment of interest, wherein
Energy_{(financial instrument)}=Years to Maturity_{(financial instrument)} [Coupon of Rate_{(financial instrument)}]².

2. In the invention of claim 1, computational code of said energy of a financial instrument, wherein
Energy (as computational code): E=m*(c\hat{ }02)
where m=mass of instrument (years to maturity)
c=constant of rate of speed (annual coupon rate).

3. In the invention of claim 1, wherein charting, graphing, or tabling the data of said process.

4. In the invention of claim 1, wherein printing, storing, or displaying the data of said process.

5. A process determining the relativistic kinetic energy of a financial instrument, and producing data, wherein
$$Relativistic Kinetic Energy ( RKE ) = \frac{{mc}^{2}}{\sqrt{/ 1 - \frac{{u}^{2}}{{c}^{2}} /}} - {mc}^{2} \\ where m = mass of instrument ( years to maturity ) \\ c = constant of rate of speed ( annual coupon rate ) \\ u = yield ( annualized basis ) .$$

6. In the invention of claim 5, the total energy of a financial instrument, wherein
Total Energy(TE)=RKE+mc²
where RKE =relativistic kinetic energy
m=mass of instrument (years to maturity)
c=constant of rate of speed (annual coupon rate),
wherein further comprising computational code
Total Energy (as computational code): TE=RKE+(m*(c\hat{ }2));
where RKE=relativistic kinetic energy
m=mass of instrument (years to maturity)
c=constant of rate of speed (annual coupon rate)
u=yield (annualized basis).

7. In the invention of claim 5, computational code of said relativistic kinetic energy, wherein Relativistic Kinetic Energy (as computational code):
RKE=((m*(c\hat{ }2))/(SQRT(ABS(1−(u\hat{ }2)/(c\hat{ }2))))))−(m*(c\hat{ }2));
where m=mass of instrument (years to maturity)
c=constant of rate of speed (annual coupon rate)
u=yield (annualized basis).

8. In the invention of claim 5, wherein charting, graphing, or tabling the data of said process.

9. In the invention of claim 5, wherein printing, storing, or displaying the data of said process.

10. A method computing an augur of price movement, wherein either increase or decrease, comprising:
utilizing the inputs of m(years to maturity), c(annual coupon rate) and u(yield, annualized basis), and calculating the Relativistic Kinetic Energy (RKE) of the financial instrument, or the RKE of each financial instrument comprising a group;
calculating the Vector for RKE, by the specific RKE for each instrument (1, 2, . . . ): Vector RKE(1)=RKE(1); Vector RKE(2)=RKE(2)−Vector RKE(1); . . . ;
computing the Normalizer for each instrument, the difference between RKE and TE, wherein calculating TE, then Normalizer(1)=(−mc² (1)); Normalizer(2)=(−mc² (2)); . . . ;
calculating the Normalizing Vector for RKE, by the specific Normalizer for each instrument: NormVecRKE(1)=(−Norm(1)); NormVecRKE(2)=NormVecRKE(1)+(−Norm(2)); . . . ; and
calculating the difference between said Normalizing Vector for RKE of each instrument and its Vector for RKE: NVRKE−VRKE=NormVecRKE(1)−VectorRKE(1); . . . , wherein said difference prognosticating each security's likelihood to gain or lose in value, “up” or “down” respectively, positive difference augurs to gain, and negative, to lose, in value.

11. In the invention of claim 10, wherein charting, graphing, or tabling the data of said method.

12. In the invention of claim 10, wherein printing, storing, or displaying the data of said method.
